(19) United States
(12) Patent Application Publication
(10) Pub. No.: US 2018/0128216 A1
(43) Pub. Date: May 10, 2018

(54) REDUCING FUEL CONSUMPTION OF SPARK IGNITION ENGINES

(71) Applicant: COMBUSTION 8 TECHNOLOGIES LLC, Butler, WI (US)

(72) Inventors: Richard Eckhardt, Arlington, MA (US); Larry Daniel Nichols, Arlington, MA (US); Jim Scot Cowart, Annapolis, MD (US); David B. Cope, Medfield, MA (US)

(21) Appl. No.: 15/625,571

(22) Filed: Jun. 16, 2017

Related U.S. Application Data
(63) Continuation of application No. 14/776,234, filed on Sep. 14, 2015, now abandoned.
(60) Provisional application No. 61/790,464, filed on Mar. 15, 2013.

(51) Int. Cl. F02M 27/06; F02D 41/00; F02M 25/00; F02M 21/02; F02D 13/02

(52) U.S. Cl. CPC F02M 27/06; F02D 41/0065; F02M 26/47; F02M 26/57; F02D 41/0027; Y02T 10/47; F02M 21/0206; F02M 26/36; F02D 13/0219; F02D 2041/0075; Y02T 10/32; F02M 25/00

(57) ABSTRACT

Atomic oxygen is provided for the purpose of promoting reliable ignition and smooth combustion in a spark ignition internal combustion engine is to disperse a low concentration of an atomic oxygen precursor, such as nitrous oxide (N₂O), into the flammable mixture of air and gasoline vapor prior to the time of ignition. The introduction of N₂O may take place in the intake manifold, in the stream of exhaust gas being returned as part of the EGR process, or directly into the combustion chamber (for example through a small orifice in the base of the spark plug or through a small nozzle located elsewhere in the cylinder head). Introduction of N₂O directly into the combustion chamber may be continuous, or it may be pulsed so as to occur at the time of, or shortly before, spark ignition.

### CROSS-REFERENCE TO RELATED APPLICATIONS

This application is a continuation application of U.S. application Ser. No. 14/776,234 filed Sep. 14, 2015, which is a U.S. National Stage Application of International Patent Application PCT/US2014/027279 filed Mar. 14, 2014, which claims the benefit of Provisional Application No. 61/790,464 filed on Mar. 15, 2013, the entire content of which is incorporated herein by reference.

### TECHNICAL FIELD

This submission relates to methods and apparatus for substantially increasing spark ignition engine efficiency, specifically by combining high exhaust gas recirculation with a source of atomic oxygen.

### BACKGROUND

Spark ignition (SI) engines power many automobiles and small trucks in the United States and abroad. Their efficient operation is considered a matter of economic, environmental and resource conservation importance.

An SI engine is a type of internal combustion engine in which a liquid hydrocarbon fuel is vaporized into the intake airstream prior to its entry into each cylinder. The resulting flammable mixture is then ignited shortly before top dead center (TDC) by a carefully timed electric spark. The flame front which spreads from the point of ignition heats the gas and produces a high pressure, thus exerting a force on the piston and delivering useful mechanical work through the crankshaft to an external load.

FIGS. 1A through 1D show the sequence of strokes—intake (FIG. 1A), compression (FIG. 1B), power (FIG. 1C), and exhaust (FIG. 1D)—by which a four-cycle SI engine 100 operates. During the intake stroke, shown in FIG. 1A, a mixture of air and fuel vapor (indicated by arrow 122) is drawn into the cylinder 115 as the intake valve opens 130 and the piston 120 descends (indicated by arrow 124). During the following compression stroke, shown in FIG. 1B, both the intake valve 130 and an exhaust valve 140 are closed and the rising piston 120 (indicated by arrow 126) compresses the gas, increasing its pressure and temperature. The spark plug 150 then fires, causing combustion to spread rapidly throughout the combustion chamber 115. The resulting release of heat energy causes a large increase in temperature and pressure, which forces the piston 120 downward (indicated by arrow 128) during the power stroke, as illustrated in FIG. 1C. Finally, the exhaust valve 140 opens as shown in FIG. 1D, venting and expelling the cylinder contents during the exhaust stroke (indicated by arrow 132) in preparation for the intake stroke of the next cycle. While a 4-cycle engine is described above, the principles disclosed herein can be applied to other types of engine (e.g., 2-cycle engines).

The most common SI engine fuel, commonly called gasoline in the United States, is a mixture of refined petroleum hydrocarbons sufficiently volatile to vaporize rapidly in the intake airstream, and sufficiently branched and rich in aromatics to resist auto-ignition. Other auto-ignition resistant substances such as natural gas or biofuels are also in use. Auto-ignition, which occurs when a substance spontaneously ignites due to an increase in temperature, can lead to knocking in a spark ignition engine under high loads.

For the combustion temperatures attained in conventional SI engines the laws of thermodynamics do not allow more than about 60% of the heat of combustion to be converted into useful work. The actual efficiency is further reduced by incomplete combustion, in-cylinder heat losses to the cooling system, the heat, pressure and kinetic energy vented into the exhaust, and mechanical friction. As a result, most vehicular spark ignition engines convert only 25% to 35% of the heat of combustion into useful mechanical work.

For the reasons set forth above, methods and systems that allow utilization of a larger fraction of the combustion energy available in fuel, at a cost not exceeding the benefit, would provide valuable increases in power and mileage, and at the same time benefit the environment and improve resource conservation.

Other than mechanical friction, all of the factors limiting the efficiency of SI engines are intimately tied to the conditions prevailing during in-cylinder combustion. In particular, heat loss to the walls could be reduced by causing the air-fuel mixture to burn at a lower temperature. This would reduce the temperature gradient driving heat into the walls, and it would lower the temperature and pressure lost when the exhaust valve opens, provided that spark timing is advanced sufficiently to allow combustion to be substantially complete before the exhaust valve opens.

One way to achieve a cooler flame is by recirculating some exhaust gas back into the intake airstream, while at the same time reducing the amount of incoming fuel so as to maintain a balanced combustion stoichiometry. By diluting both fuel and oxygen, many of the steps involved in ignition and combustion are slowed down; this is a consequence of the fundamental mass-action law of chemical kinetics, which says that the speed of a reaction is proportional to the product of the concentrations of the reacting species.

Exhaust gas recirculation (EGR) in the 5% to 30% range based on total cylinder intake, by mass, exclusive of fuel has been employed in almost all automotive vehicles produced in the United States since the 1990's. This practice was adopted primarily to reduce NOx emissions by lowering the flame temperature, but it also moderately improved the efficiency and mileage of SI engines. Although unregulated EGR can lead to a small reduction in maximum power, this can be avoided by adjusting the amount of EGR in response to engine load and RPM, for example by turning it off completely at wide open throttle.

It is recognized in the field that even more fuel savings could be achieved by higher levels of EGR, but this attractive prospect is blocked by two problems. Namely, at high levels of EGR, spark ignition becomes unreliable, causing the engine to misfire, and the propagation of the flame front becomes irregular. Either of these problems can cause the engine to run roughly or stall. They are the result of EGR's reduction in the concentration of fuel and oxygen, which slows both the free radical generating reactions which lead to ignition, as well as the free radical chain propagating reactions which support the spread of combustion.

### SUMMARY

In general, in an aspect, a method for improving the efficiency of a spark ignition internal combustion engine includes providing charge dilution by exhaust gas recirculation (EGR) at a ratio of 20% or more, and introducing atomic oxygen into the combustion chamber, at or shortly before the time of spark ignition.

Implementations of this aspect may include one or more of the following features:

For example, in some implementation, the EGR ratio can be 20% to 50%. Charge dilution can be provided by an alternative technique such as variable valve timing. The atomic oxygen can be introduced between the time of spark ignition and 2 msec before that time. The atomic oxygen can be conveyed by an unstable or metastable oxygen precursor, such as nitrous oxide or ozone, from which atomic oxygen can be released by the heat of a spark or flame. The atomic oxygen can be produced by a flash of optical radiation rich in short wavelength UV entering the combustion chamber through a suitably durable and transparent window. The atomic oxygen can be produced by a high current electrical arc between two closely spaced electrodes inside the combustion chamber, said atomic oxygen being generated both by the heat of the arc and by the short wavelength UV radiation emitted by the arc.

In some implementations, the nitrous oxide can be stored as a pressurized liquid in a suitable tank. In some implementations, the flow of nitrous oxide can be controlled by one or more suitable metering valves or positive displacement pumps linked electronically to the EGR control modules of the engine. The nitrous oxide can be introduced into the intake manifold airstream. The nitrous oxide can be introduced into the stream of exhaust gas returning from the EGR valve. The nitrous oxide can be introduced through a port located near the base of the spark plug. The nitrous oxide can be introduced through a port passing through the spark plug or the base of a spark plug. The volume of liquid nitrous oxide delivered to the engine can be between 0.25% and 2.5% of the volume of liquid fuel delivered to the engine.

In some implementations, the pulse of ultraviolet light can be produced by a short arc xenon flash lamp and can be introduced into the combustion zone through a window or optical coupling. The window or optical coupling can be made of pure synthetic fused silica or sapphire, or another thermally and mechanically stable material transparent to UV radiation at wavelengths below 200 nm. The pulse of UV rich light can be timed to occur between the time of spark ignition and 2 msec prior to that time. The timing can be achieved using a crankshaft angle detector, a processing system, and a data storage medium containing instructions which, when executed by said processing system with input from said detector, cause the processing system and detector to control the timing of the ultraviolet light pulse in a predetermined manner. The atomic oxygen can be introduced by an exposed electric arc dissipating at least 0.5 joule of energy. The electric arc unit can replace a conventional spark plug. The arc can be timed to occur at the time when a conventional spark plug would fire, or at another time adjusted to compensate for the more rapid ignition induced by the presence of atomic oxygen and the slower combustion induced by EGR.

In some implementations, the energy for the electric arc can be stored in one or more capacitors. A high voltage pulse can be delivered to a third electrode in order to trigger the electrical discharge. The timing of the arc can be controlled by a data storage system and an electronic control unit linked to an EGR control unit and a spark control unit similar to those currently included as standard equipment on vehicles equipped with spark ignition engines.

In general, in another aspect, a system capable of improving the mileage of a vehicle equipped with a spark ignition internal combustion engine includes a means for introducing atomic oxygen into each combustion chamber and a means for adjusting the exhaust gas recirculation ratio.

Implementations of this aspect may include one or more of the following features:

For example, in some implementations, the EGR means can be replaced by alternative means for charge dilution such as variable valve timing. The system can include means for adjusting the EGR ratio in the range from 0% to 50%. The system can include means to control the timing of the introduction of atomic oxygen into the combustion chamber between 0 and 2 msec before the time of spark ignition. The means for introducing the atomic oxygen into the combustion chamber can be an unstable or metastable oxygen precursor, such as nitrous oxide or ozone, from which atomic oxygen can be released by the heat of a spark or flame. The means for introducing nitrous oxide can deliver said nitrous oxide into the intake manifold, or into the exhaust stream returning from the EGR valve, or directly into the combustion chamber.

In some implementations, the means for introducing atomic oxygen into the combustion chamber can be a source of optical radiation external to the combustion chamber, said optical radiation containing at least 1% of UV radiation with a wavelength shorter than 220 nm, together with means to allow illumination of a large portion of the combustion chamber by said optical radiation. The source of optical radiation can be a pulsed xenon flash lamp. The means allowing illumination can be a window made of pure synthetic silica or sapphire, or some other thermally and mechanically stable material transparent to said radiation. The means allowing illumination can include UV-transparent lenses or other optical components capable of focusing and directing the optical radiation into the combustion chamber.

In some implementations, the system can include means to control the timing of the flash of optical radiation, said means comprising a crankshaft angle detector, an EGR control module, a processing system, and a data storage medium containing instructions which, when executed by said processing system with input from said detector, control the timing of the optical pulse in a predetermined manner.

In some implementations, the means for introducing atomic oxygen into the combustion chamber can be a source of optical radiation internal to the combustion chamber, said radiation containing at least 1% of UV radiation with a wavelength shorter than 220 nm. The source of optical radiation can be a means for generating a pulsed high-current electrical arc between metal electrodes located inside the combustion chamber. The means for generating an electrical arc can replace a conventional spark plug. The system can include means to control the timing of the electrical arc, said means comprising a crankshaft angle detector, an EGR control module, a processing system, and a data storage medium containing instructions which, when executed by said processing system with input from said detector, control the timing of the pulsed electrical arc in a predetermined manner.

In general, in another aspect, a system capable of improving the mileage of a vehicle equipped with a spark ignition internal combustion engine includes a means for adjusting the exhaust gas recirculation (EGR) ratio, and a means for introducing atomic oxygen into each combustion chamber. Said means includes one of the following: (i) a source delivering nitrous oxide into the intake manifold, the returning exhaust stream, or each combustion chamber; (ii) a pulsed xenon flash lamp shining through suitable UV-transparent optics into each combustion chamber; or (iii) a high current electrical arc between metal electrodes located inside each combustion chamber in place of a conventional spark plug. Together with means, where appropriate, to control the timing of the introduction of atomic oxygen, said means includes a crankshaft angle detector, an EGR control module, an electronic processing system, and a data storage medium, together and jointly controlling the timing of atomic oxygen delivery.

In general, in another aspect, a method includes delivering a gas and fuel to a combustion chamber of a spark ignition internal combustion engine, where about 20% or more of the gas, by mass, is recirculated exhaust gas from the internal combustion engine. The method also includes providing atomic oxygen in the combustion chamber at the time of or before ignition of the fuel in the combustion chamber, and causing the fuel in the combustion chamber to ignite.

Implementations of this aspect may include one or more of the following features:

For example, in some implementations, about 20% to 50% of the gas can be recirculated exhaust gas from the internal combustion engine. The atomic oxygen can be provided within 2 milliseconds of ignition of the fuel in the combustion chamber. The atomic oxygen can be provided by delivering a precursor to the fuel. Providing the atomic oxygen can include heating the precursor. The precursor can be nitrous oxide or ozone. The precursor can be nitrous oxide and a volume of nitrous oxide delivered to the combustion chamber can be between 0.25% and 2.5% of the volume of the fuel.

In some implementations, the atomic oxygen can be provided by directing UV radiation to the combustion chamber. The UV radiation can be produced from a light source located outside of the combustion chamber. The UV radiation can be produced within the combustion chamber. The UV radiation can be produced by an electrical discharge within the combustion chamber. The UV radiation can be directed within 2 milliseconds of ignition of the fuel in the combustion chamber.

In some implementations, the method further includes controlling a timing of providing the atomic oxygen relative to the ignition. The timing can be controlled based on a position of a crankshaft driving a piston in the combustion chamber.

In some implementations, providing the atomic oxygen in conjunction with the gas and fuel can improve a gas mileage of a vehicle utilizing the internal combustion engine.

In general, in another aspect, a spark ignition internal combustion engine includes a first means for providing atomic oxygen in one or more combustion chambers of the internal combustion engine, a second means for adjusting an exhaust gas recirculation ratio, and an electronic controller in communication with the first and second means. The electronic controller is programmed to cause the first means to provide atomic oxygen in the one or more combustion chambers while causing the second means to provide an exhaust gas recirculation ratio of about 20% or more.

Implementations of this aspect may include one or more of the following features:

For example, in some implementations, the first means can include a nitrous oxide source arranged to deliver nitrous oxide to the one or more combustion chambers. The nitrous oxide source can be arranged to deliver nitrous oxide to the one or more combustion chambers by delivering nitrous oxide to an intake manifold of the internal combustion engine. The nitrous oxide source can be arranged to deliver nitrous oxide to the one or more combustion chambers by delivering nitrous oxide to an exhaust stream of the internal combustion engine. The nitrous oxide source can be arranged to deliver nitrous oxide directly to the one or more combustion chambers.

In some implementations, the first means can include one or more light sources arranged to deliver UV radiation to the one or more combustion chambers. The one or more light sources can include a flash lamp. The flash lamp can be a pulsed Xenon flash lamp.

In some implementations, the one or more light sources can be positioned outside the combustion chambers and each combustion chamber can include an optical element that transmits UV radiation from the one or more light sources into the respective combustion chamber. The optical elements can include a window or a lens. The optical elements can include an optical waveguide.

In some implementations, the first means can include an arc current device that includes a pair of electrodes positioned to provide an electrical arc discharge within one of the combustion chamber.

In some implementations, the internal combustion chamber can further include a means for controlling the timing of the introduction of atomic oxygen. The means for controlling the timing of the introduction of atomic oxygen can cinlude a crankshaft angle detector, an EGR control module, and an electronic processing system in communication with the crankshaft angle detector and EGR control module and programmed to control the timing of the introduction of atomic oxygen into the one or more combustion chambers based on signals from the crankshaft angle detector and the EGR control module.

In general, in another aspect, a spark ignition internal combustion engine includes a precursor source containing a precursor of atomic oxygen, a regulator for regulating delivery of the precursor to one or more combustion chambers of the internal combustion engine, an exhaust gas recirculator for delivering gas exhausted from the one or more combustion chambers back to the one or more combustion chambers, and an electronic controller in communication with the regulator and the exhaust gas recirculator. The electronic controller is programmed to cause the regulator to provide atomic oxygen to the combustion chamber prior to or at a time of ignition in the combustion chamber.

In some implementations, the precursor can be nitrous oxide.

In general, in another aspect, a spark ignition internal combustion engine includes a light source for producing UV radiation, one or more optical elements arranged to transmit the UV radiation to a combustion chamber of the internal combustion engine, and an electronic controller in communication with the light source. The electronic controller is programmed to cause the light source to provide UV radiation to the combustion chamber prior to or at a time of ignition in the combustion chamber.

In some implementations, the engine can further include an exhaust gas recirculator for delivering gas exhausted from the one or more combustion chambers back to the one or more combustion chambers.

In general, in another aspect, a spark ignition internal combustion engine includes an electric discharge device that includes two or more electrodes positioned to provide an electrical arc discharge sufficient to generate atomic oxygen within a combustion chamber of the internal combustion engine, and an electronic controller in communication with the electric discharge device. The electronic controller is programmed to cause the electric discharge device to provide an electrical arc discharge within the combustion chamber prior to or at a time of ignition in the combustion chamber.

In some implementations, the engine can further include an exhaust gas recirculator for delivering gas exhausted from the one or more combustion chambers back to the one or more combustion chambers.

In general, in another aspect, a motor vehicle can include an implementation of an engine described above.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A-D show a sequence of strokes of an example spark ignition (SI) engine.

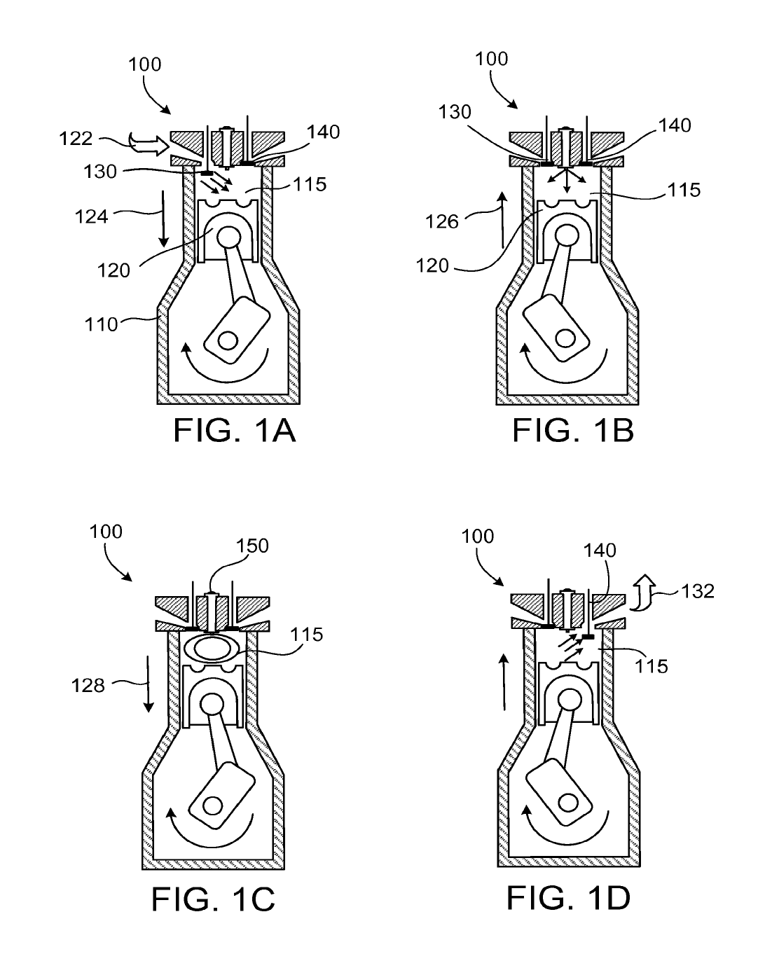

FIG. 2 shows a portion of an example SI engine equipped for the introduction of N₂O.

FIG. 3 shows an example component for supplying a pulse of UV-rich light to the interior of an SI engine combustion chamber.

FIG. 4 shows an example electric arc flash unit.

FIG. 5 shows the top of one cylinder of an example SI engine installed with the electric arc flash unit of FIG. 4.

FIG. 6 shows an example electronic circuit used to create an electric arc.

### DETAILED DESCRIPTION

An important factor controlling combustion reactions is the nature of the oxidizing species present. Normally the only such species is molecular oxygen, O₂, which for quantum mechanical reasons reacts relatively slowly with fuel molecules. Oxygen atoms would be capable of reacting more rapidly, but combustion temperatures are not high enough to dissociate O₂ into significant amounts of free O. Thus, it is believed that ignition of gasoline vapor should make use of slower reactions involving molecular oxygen, including but not limited to the following:

R—H+O═O->R.+H—O—O.,

R—H+H-O—O.->R.+H-O—O—H,

H—O—O—H->2HO.,

R—H+HO.->R.+H₂O,

R.+O═O->R—O—O., etc.,

where RH is a hydrocarbon molecule and R is the corresponding alkyl radical.

Provided there is enough oxygen and fuel, these reactions combine to produce temperatures and free radical concentrations high enough to initiate an avalanche of chain reactions, allowing a flame to ignite and propagate. But, as the amount of EGR increases, the rate of these O₂-based reactions falls below the critical level required to initiate and support combustion. This is believed to limit the amount of EGR which can be employed.

It is believed that it is possible to avoid this limitation by introducing trace amounts (e.g., as little as 10 ppm to 100 ppm) of atomic oxygen (O), thereby providing additional exothermic reactions capable of facilitating both ignition and flame propagation. Such reactions include, but are not limited to, the following:

R—H+O:->R.+HO.

R—H+HO.->R.+H₂O

R.+O:->RO., etc.

Accordingly, methods are disclosed which can be used to introduce a small but effective concentration of atomic oxygen into the combustion chamber at a time and location where it can promote reliable ignition and facilitate smooth combustion at EGR levels approaching 50%.

One approach to providing atomic oxygen for the purpose of promoting reliable ignition and smooth combustion is to disperse a low concentration of an atomic oxygen precursor, such as nitrous oxide (N₂O), into the flammable mixture of air and gasoline vapor prior to the time of ignition. The introduction of N₂O may take place in the intake manifold, in the stream of exhaust gas being returned as part of the EGR process, or directly into the combustion chamber (for example through a small orifice in the base of the spark plug or through a small nozzle located elsewhere in the cylinder head). Introduction of N₂O directly into the combustion chamber may be continuous, or it may be pulsed so as to occur at the time of, or shortly before, spark ignition.

It should be noted that N₂O could also be introduced as a solute in the fuel. In some implementations, however, once the fuel is vaporized on its way to the cylinder, the N₂O would become dispersed in exactly the same way as if it had been injected directly into the manifold. Therefore, in some implementations, it may be preferable to directly inject N₂O into the combustion rather than adopt a more complex solute route.

When heated, nitrous oxide dissociates to produce nitrogen and atomic oxygen:

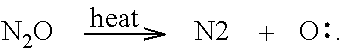

This heat-catalyzed reaction will begin near the spark and thereafter follow the expanding flame front, thus assisting in both ignition and flame propagation. We have found that as little as 1.25 wt-% of nitrous oxide, based on the rate of fuel consumption, can be combined with 20% to 50% EGR to achieve improvements in mileage in excess of 25%.

This technique is not to be confused with the practice of introducing a pound or more per minute of N₂O into racing engines to produce a large but necessarily brief increase in engine power. This method of power enhancement is attributable to two factors:

(1) N₂O contains 36% oxygen, compared with 21% in air, so when N₂O is used to replace a large fraction of the incoming air the engine can burn more fuel and produce more power.

(2) N₂O is a refrigerant which, when stored as a pressurized liquid and then released into the inlet airstream, causes a drop in temperature. This increases the density of the intake gas and provides even more oxygen.

Many factors distinguish the use of N₂O disclosed here from conventional N₂O use. For example, the low levels of N₂O used in the described methods would not be sufficient for boosting power in a conventional way, and the power boosting use of large quantities of N₂O does not rely on the concurrent use of EGR. In fact, the inventors are not aware that any connection between the use of EGR and the use of N₂O has been previously proposed or reported in the past.

Tanks of liquefied N₂O are classified as safe for public sale and interstate transport. Such tanks are commercially available and can be handled in much the same manner as tanks of liquid carbon dioxide. Liquid N₂O is not susceptible to explosion, and it is completely destroyed by engine combustion, so even though N₂O is an energy rich compound and a greenhouse gas, its handling and combustion should not raise safety or pollution concerns.

Alternatively, or in addition to the use of N₂O to provide atomic oxygen to facilitate high EGR combustion, is the use of an intense burst of short wavelength UV light projected through a UV-transparent window directly into the combustion chamber of an SI engine at the time of, or shortly before, the spark. It is believed that such irradiation can produce enough free O atoms, at the right time, to allow smooth and efficient engine operation at high EGR levels.

The dissociation energy of an O₂ molecule corresponds to a photon wavelength of 242 nm. Radiation at shorter wavelengths is strongly absorbed by O₂, with copious production of free O atoms. Ambient air, which is 21% oxygen, interacts with such UV so strongly that it can travel only a short distance before being absorbed.

The degree of absorption of UV light by O₂ increases rapidly at wavelengths shorter than 242 nm. In order to produce a burst of O atoms throughout a significant volume near the top of the compression stroke, the UV radiation should be largely absorbed while traveling a distance between 0.5 and 5.0 cm, which will allow it to deposit most of its energy throughout a significant volume before reaching the walls. In compressed air that path length corresponds to wavelengths just below 220 nm. Thus UV with a wavelength of about 180 to 220 nm is representative of radiation suitable for dissociating O₂ into O atoms throughout a significant volume of the combustion chamber.

In a short-arc xenon discharge lamp a brief high current arc is struck between two closely spaced metal electrodes in a xenon atmosphere. The result is a powerful burst of visible and ultraviolet radiation comprised of characteristic xenon emission lines superimposed on a background of black-body radiation. Such a lamp, for example, the Excelitas model 4402 (commercially available from Excelitas Technologies Corp., Waltham, Mass.), can be operated at power levels as high as 60 watts while flashing 60 times a second and delivering up to 100 mJ of total optical energy per flash. As much as 2 mJ of that radiation can be at wavelengths below 220 nm. That proves to be sufficient to dissociate enough O₂ molecules to allow smooth SI engine operation at EGR levels over 35%.

To make effective use of the optical output of a xenon flash lamp, suitable optics should be fabricated from a material highly transparent in the 180 to 200 nm range and thermally and mechanically strong enough to survive prolonged exposure to combustion conditions. Commercially available synthetic fused silica and sapphire are examples of such materials. Such UV-transparent optical components will not become occluded by combustion products, because enough UV, visible and infrared energy will be absorbed by any deposit to vaporize or displace it.

A further method of creating an intense flash of radiation capable of dissociating oxygen molecules is to strike an electric arc directly in the air-fuel mixture inside the combustion chamber, rather than in an enclosed lamp external to the combustion chamber. In such embodiments, the electrodes that create the electrical arc are not enclosed, and can therefore take the place of a conventional spark plug. In some embodiments, arc electrodes are positioned inside each engine cylinder so that the light emitted from the arc illuminates all or almost all of the cylinder volume. Thus, not only does the arc serve to ignite the combustible mixture in a manner similar to a conventional spark plug, the intense radiation from the arc also generates atomic oxygen which can serve locally to promote ignition, and serve to promote flame propagation throughout the combustion chamber.

A high current electrical arc in air is known to produce a significant amount of UV light. For example, workers using arc welding equipment must wear protective clothing to prevent skin or eye damage from the intense UV light created by the welding arc through air. In fact, at high current density, air is nearly as efficient at generating UV light as a xenon arc lamp. Because of the xenon line spectrum, xenon arc lamps produce some UV light efficiently when operated at low current density, but when operated at high current density the UV light output is primarily the result of the very high temperature gas acting as a black body radiator.

In certain configurations, an electric arc is positioned inside the engine cylinder and driven to produce a flash of intense UV light throughout the chamber at the same time as the arc ignites the combustible mixture. This results in the wide-spread production of monatomic oxygen capable of enhancing the combustion process. This is to be distinguished from a conventional spark plug, which lacks sufficient energy to produce significant amounts of atomic oxygen, and therefore does not facilitate the chemistry of ignition and combustion.

In the following embodiments, an elevated level of EGR, typically 25% to 50%, is used to obtaining mileage improvements of approaching or exceeding 25% (e.g., 10% or more, 15% or more, 20% or more, up to 30% or more). This condition can be obtained by minor readjustments of the EGR components and control mechanisms already present in conventional on-the-road SI engines in the United States and many other countries.

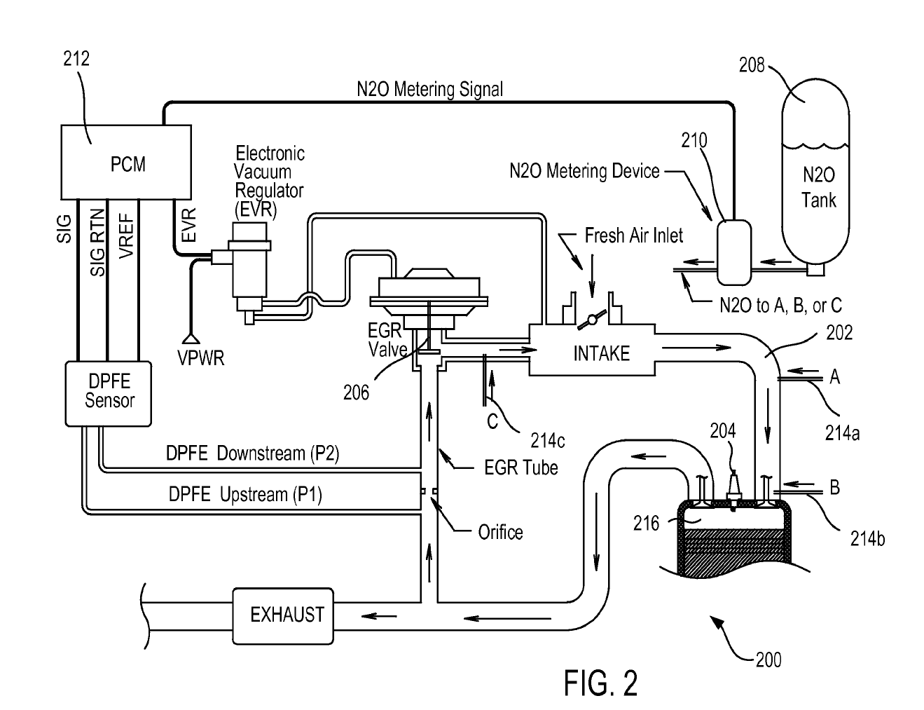

FIG. 2 show a schematic drawing of a portion of an SI engine 200 equipped for the introduction of N₂O at three possible sites, labeled respectively A, in the intake manifold 202; B, through or near the spark plug 204; and C, in the exhaust stream coming back from the EGR valve 206. Liquid N₂O from a pressurized holding tank 208 passes through a metering valve or positive displacement pump 210 regulated by a control circuit keyed to the existing PCM 212 (which may include a data storage medium, such as a memory chip, and an electronic processor, such as an ASIC). The N₂O then passes through a small nozzle 214a, 214b, or 214c at one of the locations A, B or C, respectively, where it flash evaporates and is drawn into the engine. For a more complete explanation of the acronyms in FIG. 2 see Example 1, below.

In location B, the nozzle 314b may be incorporated into the spark plug design or located separately near the spark plug 304, and the flow of N₂O may either be steady, or pulsed under the control of the spark and EGR control circuits. Other configurations beside those shown in these figures can be used to introduce ignition and combustion promoting quantities of N₂O into an SI engine.

In some embodiments, an intense flash of light, rich in short wavelength UV radiation, is introduced directly into the combustion chamber 316 near or shortly (e.g., 10 milliseconds or less, 8 milliseconds or less, 5 milliseconds or less, 3 milliseconds or less, 2 milliseconds or less, 1 millisecond or less) before the desired time of ignition.

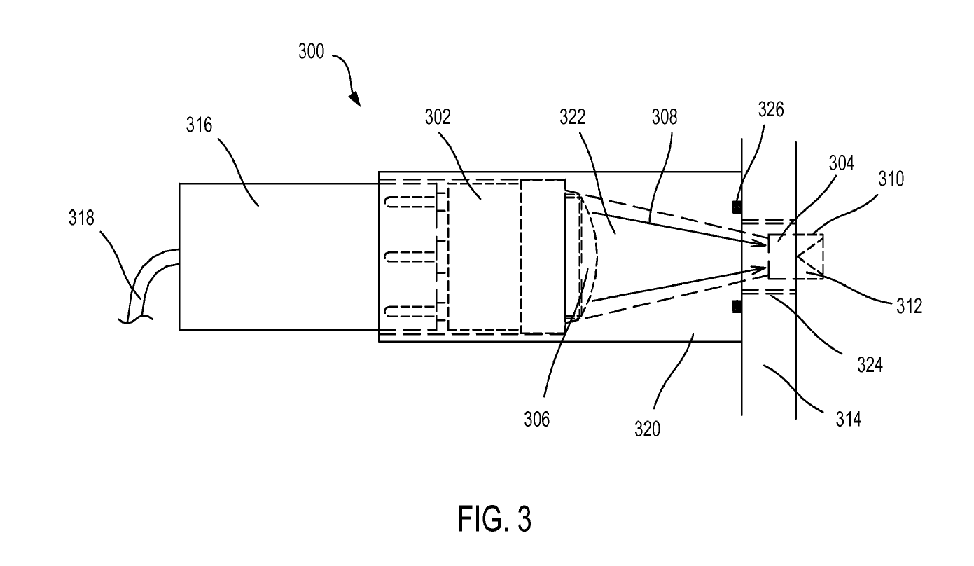

FIG. 3 illustrates an exemplary component 300 for supplying a pulse of intense UV-rich light to the interior of an SI engine combustion chamber. In this embodiment, the light is produced by a short-arc xenon flash lamp 302, though other light sources can be used. This flash lamp 302 includes an integral reflector (e.g., a parabolic reflector) to collimate the majority of its light into parallel rays. For practical considerations in the construction of many internal combustion engines, the window 304 passing UV light into the cylinder should be relatively small, for example 2 to 10 mm in diameter, and preferably 4 to 8 mm in diameter. To direct the collimated rays of light from the flash lamp 302 through the window 304 a UV-transparent condensing lens 306 is used to focus the light 308 from the flash lamp 302 onto the window 304. For transparency toward short wavelength UV, the condensing lens 306, window 304, and window extension 310 can be made of synthetic fused silica, sapphire, or another strong, heat-resistant, UV transparent material. Likewise, the flash lamp 302 envelope uses one of these UV transparent materials to allow the UV light to exit. An alternative construction is to use a flash lamp 302 with an ellipsoidal reflector which provides focused rather than collimated light, thus eliminating the need for the condensing lens 306.

FIG. 3 also shows an alternate window shape 310 that includes a protrusion 312 into the engine cylinder. This protrusion 312 has a concave depression in the end, such as a conical indentation, to provide a reflective surface or total internal reflection surface to distribute the light inside the cylinder for more effective illumination of the combustion volume. The window extension 310 may be asymmetrical, particularly if the window 304 is not centered in the top of the cylinder head 314. The shape of the extension 310 can be used to distribute the light in an optimum pattern within the engine cylinder.

In addition to the optical components, this configuration includes an electrical connector and trigger module 316 for the flash lamp 302. This module 316 has one or more wires 318 that connect to a power source and a flash timing controller (not shown) that assures that the flash of light occurs with the desired intensity and at the desired time.

A mechanical housing 320 holds all the optical and electrical components in the proper position and contains a UV-transparent atmosphere 322 such as a near vacuum, nitrogen gas, or another gas that does not significantly absorb the short wavelength UV. The mechanical housing 320 includes a threaded protrusion 324 that holds the window 304 and screws into the engine cylinder head 314 to direct the light 308 into the cylinder. A pressure seal 326 is included around the threaded protrusion 324 to contain the high pressure gasses in the engine cylinder. The mechanical housing 320 is preferably hexagonal in cross-section for easy screwing and tightening into the cylinder head 314. This mechanical configuration can be easily attached to or detached from the engine (with the same ease as a spark plug) for installation, repair or replacement.

Yet another method for creating an intense flash of light containing short wave UV radiation is to use an exposed electric arc in a reactive atmosphere (e.g., air), rather than an enclosed arc in an inert gas such as xenon. The arc electrodes can be positioned inside each engine cylinder so all the light emitted from the arc permeates the cylinder volume. This eliminates the costs and losses associated with the optics necessary to direct light from an external source into the cylinder, and the exposed arc serves simultaneously to provide spark ignition.

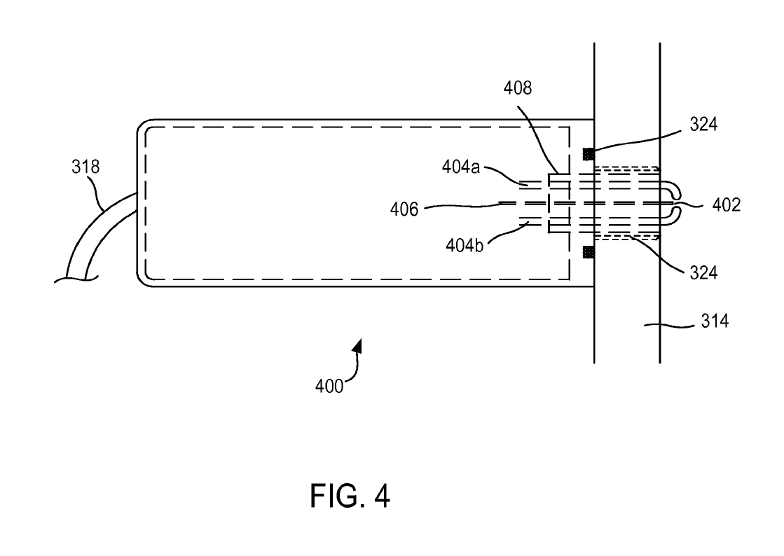

FIG. 4 shows an example configuration of an electric arc flash unit 400 useful for creating an intense flash of light, containing short wavelength UV radiation, directly inside an SI engine combustion chamber. In this exemplary component the electric arc 402 is created between two arc electrodes 404a and 404b which extend through the cylinder head 314 into the internal volume of the engine cylinder in or near the position normally occupied by a conventional spark plug. The arc electrodes are connected to a source of electrical energy of sufficient voltage (typically 1,000 to 3,000V) to create a high energy electric arc between the arc electrodes 404a and 404b. Because of the elevated air pressure in the cylinder, a third higher voltage trigger electrode 406 is used to initiate the arc and control the precise timing.

The energy for the electric arc 402 is stored in one or more capacitors that are contained in the housing of the electric arc flash unit 400, or alternatively in a remote location dictated by available space or other considerations. Control wires 318 connect to the control electronics (not shown) to provide the energy to charge the capacitors, and to provide the trigger signal to initiate the electrical arc 402 at the desired time. If the energy storage capacitors are in a remote location, these wires include the two conductors that connect directly to the arc electrodes 404a and 404b. In general, the control electronics can include standard and/or custom components, such as data storage media (e.g., a non-volatile memory chip) and an electronic processor (e.g., an ASIC).

The electric arc flash unit 400 includes a threaded protrusion 324 that is screwed into a hole in the cylinder head 314. The central portion of this protrusion is filled with a high temperature insulating material 408, such as a ceramic, to keep the electrodes 404a, 404b, and 406 electrically isolated from each other and provide a gas-tight seal. A pressure seal 326 is also included around the threaded protrusion 324 to provide an additional seal against gas leakage.

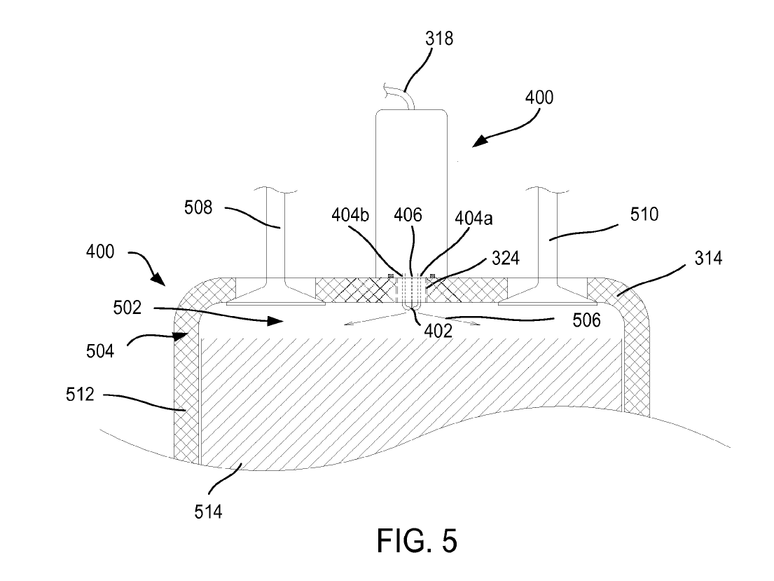

FIG. 5 shows a simplified diagram of the top of one cylinder of an SI engine 500 with the electric arc flash unit 400 installed so that the threaded protrusion 324 extends through the engine cylinder head 314 into the combustion space 502 at the top of the engine cylinder 504 in the position normally occupied by a spark plug. The electric arc flash unit 400 is positioned so that the optical and UV radiation 506 from the electric arc 402 can illuminate virtually the entire combustion volume 502.

One or more wires 318 connect the electric arc flash unit 400 to a power source and flash timing controller (not shown) that cause an arc and its associated flash of optical and UV radiation to occur at the desired time of ignition. At that time both the intake valve 508 and the exhaust valve 510 are closed to ensure that the gas heated by combustion is trapped within the cylinder walls 512, piston 514, and cylinder head 314 so as to exert a maximally useful force on the piston 514. The UV light and electrical energy from the electric arc flash unit 400 dissociate O₂ molecules in the air inside the cylinder to produce O atoms capable of promoting reliable ignition and smooth combustion. The timing of the electric arc flash unit can be determined by a crankshaft angle sensor and control modules already provided to time spark plug discharge.

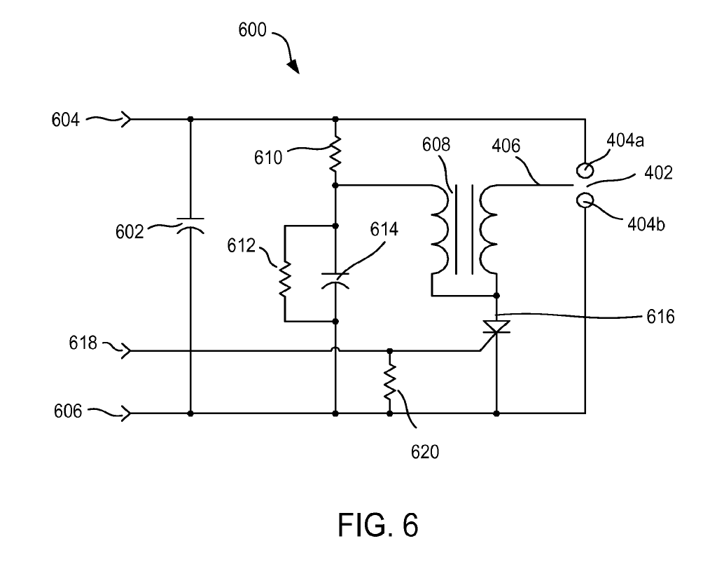

FIG. 6 shows a schematic diagram of an electronic circuit 600 that can be used to create the electric arc 402.

The circuit includes of one or more energy storage capacitors 602 that hold energy for rapid electrical current delivery to the arc electrodes 404a and 404b. To obtain the highest efficiency of UV light production the energy storage capacitors 602 should generally be charged to a voltage greater than 1,000V. If other system constraints require a lower voltage, useful results can be achieved with voltages as low as a few hundred volts. The energy storage capacitors 602 are charged from an external high voltage power supply (not shown) which applies the charging current 604 to the energy storage capacitors 602 with a ground return connection 606. The energy storage capacitors 602 are charged during the interval of time between successive electrical arcs.

The value of the energy storage capacitors 602 is chosen to provide the desired amount of energy to the flash. Flash energy will typically be in the range of 0.5 to 5 joules per flash depending on the size of the engine and other operating characteristics. The energy in the energy storage capacitors 602, in joules, is defined by the expression ½CV² where C is the total capacitor value in farads, and V is the voltage on the capacitor(s) in volts. For example, a 2 microfarad capacitor charged to 2 kV would store 4 joules of electrical energy. Because of the elevated air pressure in the cylinder, a higher voltage trigger electrode 406 is required to partially ionize the air between the arc electrodes 404a and 404b and initiate the electric arc 402 at the desired time. The trigger voltage is typically in the range from 5,000 to 50,000 volts. The trigger pulse can be very short, with a duration on the order of 1 microsecond. These pulses can be easily produced using a trigger transformer 608 designed for use with standard xenon flash lamps. Standard flash trigger transformers 608 are typically designed to be powered from a voltage of approximately 200V to 300V, so this circuit includes a voltage divider made up of resistors 610 and 612 to provide the appropriate voltage from the higher voltage energy storage capacitors 602. An additional, much smaller trigger energy storage capacitor 614 holds energy for the trigger transformer 608 to produce the high voltage trigger pulse. The trigger pulse is produced when the flash trigger SCR 616 is turned on with a flash trigger signal 618 from the control electronics (not shown). When the flash trigger SCR 616 is turned on, current flows from the trigger energy storage capacitor 614 through the flash trigger transformer 608 to electrical ground 706. The windings in the flash trigger transformer 608 have a high ratio (e.g., 20 to 100 as needed) between the secondary and primary to produce the high voltage trigger pulse to the trigger electrode 406. Resistor 620 is included to reduce the likelihood of triggers to the flash trigger SCR 716 due to spurious electrical noise on the flash trigger signal line 618. In an example implementation, Resistors 610, 612, and 620 are 1M ohm, 100K ohm, and 1K ohm resistors, respectively, trigger energy storage capacitor 714 is a 0.47 μF capacitor, trigger electrode 406 delivers a 25 KV pulse, and the voltage differential between arc electrodes 404a-b is 1 to 3 KV. Other combinations of component parameters can be used, depending on the implementation.

The benefits of EGR can also be obtained by another technique, namely variable valve timing (VVT), such as that found on General Motors' DOHC inline Six 4.2 L engine introduced on the 2002 Chevrolet TrailBlazer. Also known as cam phasing, VVT dilutes the combustible mixture in the cylinder, not by introducing exhaust gas, but by deliberately failing to expel all of the spent combustion products from the previous power stroke. By varying intake and exhaust valve timing in response to speed and load, and particularly by varying the overlap period during which both valves are open, VVT can both reduce emissions and improve engine performance. EGR, VVT and other methods of reducing the concentration of fuel and oxygen in the combustion chamber are referred to as charge dilution. Although the present invention has been described in terms of EGR it is equally applicable to these alternative methods of charge dilution.

The components, steps, features, objects, benefits and advantages that have been disclosed above are merely illustrative. Neither they, nor the discussions relating to them, are intended to limit the scope of protection in any way. Numerous other embodiments can be envisioned, including embodiments that have fewer, additional, and/or different components, steps, features, objects, benefits and advantages. Nothing that has been stated or illustrated is intended to cause a dedication of any component, step, feature, object, benefit, advantage, or equivalent to the public.

The following experiments demonstrate exemplary benefits of one or more of the implementations described above. These experiments are conducted on a two-valve 5.4 L Ford Triton V8 engine rated at 260 HP and installed in a 2004 Ford Expedition. The EGR system on this engine is diagrammed in FIG. 2. The acronyms employed in FIG. 2 are those used by the Ford Motor Company in its public literature. The EGR system employs an EGR valve, an electronic vacuum regulator (EVR), and a delta pressure feedback (DPFE) sensor.

The EGR valve is mounted on or very close to the upper intake and is connected to both the intake and the exhaust system by virtue of a special EGR Tube. The valve has a vacuum port that allows it to be opened and closed by the EVR. When the valve is open, exhaust gas flows into the upper intake where it blends with the air-plus-fuel mixture.

The DPFE Sensor measures EGR flow across an orifice located inside the special EGR Tube. The orifice is positioned between two hose ports coming off the DPFE sensor. When the EGR Valve is open, a pressure differential is created across the orifice. This difference in pressure is converted by the DPFE sensor to a voltage signal directly proportional to the flow of exhaust gas entering the intake manifold.

The power-train control module (PCM) determines optimal conditions for EGR flow and then, based on the DPFE voltage signal and some other sensor data, activates the EVR to open and close the EGR valve as necessary.

The EVR contains a solenoid with two vacuum ports. One port is connected to a vacuum source/supply, and the other is connected to the EGR valve. There is also a passage that vents vacuum to the atmosphere.

A disc inside the solenoid is moved by electro-magnetic force, as directed by the PCM. If more EGR flow is required, the PCM increases the duty-cycle to the EVR, moving the disc to close off the atmospheric vent, which in turn increases the amount of vacuum flow to the EGR valve. If less EGR flow is desired, the PCM decreases the duty-cycle to the EVR, allowing for more atmospheric venting and hence less vacuum flow to the EGR valve.

The EVR is a “normally closed” solenoid, which means that when it is de-energized, the position of the disc allows for maximum venting to the atmosphere (resulting in negligible vacuum flow to the EGR valve). The system is designed not to engage when the engine is cold or idling, or at a subfreezing temperature.

In these experiments the PCM is modified to allow the flow of exhaust gas to be increased by as much as two times its normal value, corresponding to a maximum EGR ratio as high as 50%. When using these high EGR ratios in the work described here, the spark timing was advanced in order to avoid excessive heat loss into the exhaust.

### Example 1

A small metering valve, connected to a pressurized tank of liquid N2O and controlled by the signal from the DPFE sensor, feeds a nozzle positioned in one of three locations; in the intake manifold, in or near the spark plug, and in the duct leading from the EGR valve to the intake manifold (sites A, B and C in FIG. 2). The control circuit is adjusted to introduce liquid N₂O at a rate from 0% to 1.25 wt-% based on the engine's rate of fuel consumption.

With these modifications in place, experiments are conducted to determine how engine operation and mileage are affected by given amounts of injected N₂O. In each case the level of EGR is optimized by being set at 90% of the EGR ratio which first causes a noticeable roughening of the engine. The tests are conducted during a round trip over a standard 100 km test course.

TABLE 1
Effect of Nitrous Oxide

| | Weight Ratio | Maximum | | Percent- |
|---|---|---|---|---|
| Nitrous Oxide | of Nitrous | EGR for | Miles per | age Im- |
| Introduction | Oxide to | Smooth | Gallon at 90% | prove- |
| Site | Fuel | Operation | of Max EGR | ment |
| A | 0.00% | 20% | 20 MPG | Baseline |
| A | 0.50% | 26% | 22 MPG | 10% |
| A | 1.00% | 35% | 25 MPG | 25% |
| B | 0.00% | 20% | 20 MPG | Baseline |
| B | 0.50% | 28% | 23 MPG | 12% |
| B | 1.00% | 40% | 85 MPG | 32% |
| C | 0.00% | 20% | 20 MPG | Baseline |
| C | 0.50% | 25% | 22 MPG | 8% |
| C | 1.00% | 33% | 24 MPG | 16% |

Table 1 shows the results we obtain by injecting N2O into each of the three sites indicated in FIG. 2. A significant improvement in both mileage and engine operation is seen at increasing levels EGR and N₂O. Injection directly into the combustion chamber appears to be advantageous, and injection into the returning exhaust gas is seen to be slightly less effective than injection into the intake manifold.

### Example 2

The engine in a vehicle identical with that described in Example 1 is modified by attaching a pulsed UV light source similar to that shown in FIG. 3 to each cylinder head in a position where its radiation strongly illuminates the region near the spark plug gap. The UV light source is an Excelitas model 4402 xenon flash lamp and power supply driven to deliver 1.0 J per flash. Mileage experiments are conducted over the course described in Example 1, with the UV pulse timed to end either at the time of the spark or 100 μsec before that time.

TABLE 2
Effect of Short Wavelength UV Light (Baseline = 20 MPG)

| | | Pulse End | Maximum | MPG at | Percent- |
|---|---|---|---|---|---|
| Energy Per | Pulse | Timing (μs | EGR for | 90% of | age Im- |
| Pulse | Duration | before | Smooth | Max | prove- |
| (Joules) | (μs) | Spark) | Operation | EGR | ment |
| 0.5 | 10 | 0 | 20% | 22 MPG | 10% |
| 0.5 | 10 | 100 | 19% | 21 MPG | 5% |
| 0.5 | 100 | 0 | 18% | 21 MPG | 5% |
| 0.5 | 100 | 100 | 17% | 20 MPG | 0% |
| 1.0 | 10 | 0 | 28% | 24 MPG | 20% |
| 1.0 | 10 | 100 | 26% | 23 MPG | 15% |
| 1.0 | 100 | 0 | 25% | 23 MPG | 15% |
| 1.0 | 100 | 100 | 23% | 22 MPG | 10% |
| 1.5 | 10 | 0 | 38% | 26 MPG | 24% |
| 1.5 | 10 | 100 | 34% | 25 MPG | 20% |
| 1.5 | 100 | 0 | 32% | 24 MPG | 16% |
| 1.5 | 100 | 100 | 29% | 23 MPG | 12% |

From Table 2 it can be seen that shorter pulses and shorter timing gaps are most effective. A 24% increase in mileage was obtained under the best conditions, which is about three quarters of the best improvement obtained using direct injection of N₂O.

### Example 3

Another set of experiments in a similar vehicle and engine are conducted with an air arc discharge unit, similar to that shown in FIG. 4, mounted in place of a spark plug on each cylinder in the manner illustrated in FIG. 5, and driven to deliver an arc energy of 0.5 to 1.5 joule. Arc timing is maintained at the same maximum brake torque (MBT) setting employed on this engine for conventional spark plugs. The spark or arc is usually triggered a little over 300 before TDC, resulting in peak cylinder pressure occurring about 15° after TDC.

TABLE 3
Effect of High Current Arc UV Source Replacing
Spark Plug (Baseline = 20 MPG)

| | | Maximum | MPG at | Percent- |
|---|---|---|---|---|
| Energy Per | Pulse | EGR for | 90% of | age Im- |
| Pulse | Duration | Smooth | Max | prove- |
| (Joules) | (μs) | Operation | EGR | ment |
| 0.5 | 10 | 19% | 22 MPG | 8% |
| 0.5 | 100 | 24% | 23 MPG | 12% |
| 1.0 | 10 | 23% | 24 MPG | 16% |
| 1.0 | 100 | 28% | 26 MPG | 24% |
| 1.5 | 10 | 29% | 26 MPG | 24% |
| 1.5 | 100 | 32% | 28 MPG | 32% |

As shown in Table 3, mileage increases steadily with the amount of energy per pulse and in this case, unlike Example 2, a longer duration provides better performance.

A number of embodiments have been described. Nevertheless, it will be understood that various modifications may be made without departing from the spirit and scope of the invention. Accordingly, other embodiments are within the scope of the following claims.

What is claimed is:

1. A method, comprising:
delivering a gas and fuel to a combustion chamber of a spark ignition internal combustion engine, wherein about 20% or more of the gas, by mass, is recirculated exhaust gas from the internal combustion engine;
providing atomic oxygen in the combustion chamber at the time of or before ignition of the fuel in the combustion chamber; and
causing the fuel in the combustion chamber to ignite.
